(19) United States
(12) Patent Application Publication
(10) Pub. No.: US 2024/0387116 A1
(43) Pub. Date: Nov. 21, 2024

(54) ELECTRODE FOIL FOR ELECTROLYTIC CAPACITOR, ELECTROLYTIC CAPACITOR, AND METHOD FOR PRODUCING ELECTRODE FOIL FOR ELECTROLYTIC CAPACITOR

(71) Applicant: Panasonic Intellectual Property Management Co., Ltd., Osaka (JP)

(72) Inventors: Miwa OGAWA, OSAKA FU (JP); Naomi KURIHARA, OSAKA FU (JP)

(21) Appl. No.: 18/786,069

(22) Filed: Jul. 26, 2024

Related U.S. Application Data
(63) Continuation of application No. PCT/JP2023/002785, filed on Jan. 30, 2023.

(30) Foreign Application Priority Data
Jan. 31, 2022 (JP) 2022-013231

(51) Int. Cl. H01G 9/07; H01G 9/00; H01G 9/055; H01G 9/15

(52) U.S. Cl. CPC H01G 9/07; H01G 9/0032; H01G 9/055; H01G 9/15

(57) ABSTRACT

An electrode foil for an electrolytic capacitor includes: an anode body that contains a valve action metal; a first dielectric layer that covers at least a part of the anode body; and a second dielectric layer that covers at least a part of the first dielectric layer. The second dielectric layer has a higher dielectric constant than the first dielectric layer, and a thickness T2 of the second dielectric layer is greater than a thickness T1 of the first dielectric layer. The first dielectric layer is a layer that suppresses oxygen diffusion from the second dielectric layer to the anode body.

### CROSS REFERENCE TO RELATED APPLICATION

The present application is a Continuation of International Application No. PCT/JP2023/002785, filed on Jan. 30, 2023, which claims the benefit of priority to Japanese Patent Application No. 2022-013231 filed on Jan. 31, 2022 in the Japan Patent Office, and the entire contents of the patent application are hereby incorporated by reference.

### TECHNICAL FIELD

The present disclosure relates to an electrode foil for an electrolytic capacitor, an electrolytic capacitor, and a method for producing an electrode foil for an electrolytic capacitor.

### BACKGROUND

Electrode foils of electrolytic capacitors include an anode body and a dielectric layer that covers at least a part of the surface of the anode body. A metal foil containing a valve action metal is used as the anode body. In order to increase the capacitance of the electrolytic capacitor, the surface of the metal foil is roughened by etching or the like.

Dielectric layers are formed, for example, through chemical conversion treatment on a metal foil with a roughened surface. Methods for forming dielectric layers through atomic layer deposition have also been considered (JP 2012-43960A, for example).

JP 2012-43960A is an example of related art.

### SUMMARY

When a layer of a metal oxide with a high dielectric constant (dielectric layer) is formed to increase capacitance, oxygen in the dielectric layer may migrate toward the anode body when high voltage is applied, for example, resulting in reduced insulation of the dielectric layer and increased leakage current.

One aspect of the present disclosure relates to an electrode foil for an electrolytic capacitor including: an anode body that contains a valve action metal; a first dielectric layer that covers at least a part of the anode body; and a second dielectric layer that covers at least a part of the first dielectric layer, wherein the second dielectric layer has a higher dielectric constant than the first dielectric layer, a thickness T2 of the second dielectric layer is greater than a thickness T1 of the first dielectric layer, and the first dielectric layer is a layer that suppresses oxygen diffusion from the second dielectric layer to the anode body.

Another aspect of the present disclosure relates to an electrolytic capacitor including: the above-described electrode foil for an electrolytic capacitor; and a cathode portion that covers at least a part of the second dielectric layer.

Another aspect of the present disclosure relates to a method for producing an electrode foil for an electrolytic capacitor, including: a first step of preparing an anode body that contains a valve action metal; a second step of forming a first dielectric layer that covers at least a part of the anode body; and a third step of forming a second dielectric layer that covers at least a part of the first dielectric layer, after the second step, wherein the second dielectric layer has a higher dielectric constant than the first dielectric layer, a thickness T2 of the second dielectric layer is greater than a thickness T1 of the first dielectric layer, and the first dielectric layer is a layer that suppresses oxygen diffusion from the second dielectric layer to the anode body.

According to the present disclosure, it is possible to suppress an increase in leakage current while increasing the capacitance of an electrolytic capacitor.

While novel features of the present invention are set forth particularly in the appended claims, the present invention, both as to organization and content, will be better understood and appreciated, along with other objects and features thereof, from the following detailed description taken in conjunction with the drawings.

### BRIEF DESCRIPTION OF THE DRAWINGS

FIG. 1 is a cross-sectional view schematically showing the surface portion of an electrode foil according to an embodiment of the present disclosure.

FIG. 2 is a cross-sectional view schematically showing an electrolytic capacitor according to an embodiment of the present disclosure.

FIG. 3 is a perspective view showing a wound body that has been partially unwound.

FIG. 4 is a cross-sectional view schematically showing an electrolytic capacitor according to another embodiment of the present disclosure.

### DETAILED DESCRIPTION

The following describes examples of embodiments of the present disclosure, but the present disclosure is not limited to the following examples. In the following description, specific numerical values and materials are described as examples, but it is possible to apply other numerical values and materials as long as effects of the present disclosure can be obtained. In the present specification, the wording “from a numerical value A to a numerical value B” refers to a range that includes the numerical values A and B, and can be read as “the numerical value A or more and the numerical value B or less”. When examples of a lower limit value and examples of an upper limit value are described below regarding a specific physical property or condition, any of the examples of the lower limit value and the examples of the upper limit value can be combined unless the lower limit value is larger than or equal to the upper limit value. When a plurality of materials are described as examples, it is possible to use a single material selected therefrom or a combination of two or more materials selected therefrom.

### [Electrode Foil for Electrolytic Capacitor]

An electrode foil for an electrolytic capacitor according to an embodiment of the present disclosure includes: an anode body that contains a valve action metal; a first dielectric layer that covers at least a part of the anode body; and a second dielectric layer that covers at least a part of the first dielectric layer. The second dielectric layer has a higher dielectric constant than the first dielectric layer, and a thickness T2 of the second dielectric layer is greater than a thickness T1 of the first dielectric layer. The first dielectric layer is a layer that suppresses oxygen diffusion from the second dielectric layer to the anode body.

Since the electrode foil includes a second dielectric layer with a high dielectric constant, the capacitance can be increased. Since a first dielectric layer with a low dielectric constant that has excellent insulation is interposed between the anode body and the second dielectric layer, oxygen migration from the second dielectric layer to the anode body is suppressed, the insulation of the second dielectric layer is maintained, and an increase in leakage current (LC) is suppressed. Furthermore, a decrease in withstand voltage is suppressed. Therefore, an electrolytic capacitor with a large CV value and less LC can be obtained.

If the first dielectric layer is not interposed between the anode body and the second dielectric layer, oxygen migration from the second dielectric layer to the anode body decreases the oxygen in the second dielectric layer and reduces the insulation of the second dielectric layer. The oxygen migrating from the second dielectric layer to the anode body forms an oxide film of the anode body (a film of oxide of valve action metal) on the surface of the anode body. The oxide film cannot compensate for insufficient withstand voltage of the second dielectric layer. Therefore, leakage current increases.

This oxygen migration occurs, for example, when a chemical conversion film is formed through chemical conversion treatment on a cut surface of an electrode foil after forming a wound body, or when reflow processing is performed on the electrolytic capacitor after assembly. The oxygen migration is more likely to occur when high voltage is applied or high temperature load is applied. For example, the oxygen migration is likely to occur when the above-mentioned chemical conversion treatment is performed at a formation voltage of 15 V or higher, or when reflow processing is performed at 200° C. or higher. In such cases, the effect of the first dielectric layer suppressing an increase in LC is remarkable.

### (First Dielectric Layer)

The first dielectric layer is a layer that suppresses oxygen diffusion from the second dielectric layer to the anode body (hereinafter also referred to simply as a “suppression layer”). The first dielectric layer contains a first metal oxide (hereinafter also referred to as a “first oxide”). The first oxide contains a first metal. From the viewpoint of reducing LC, the first metal is preferably at least one selected from the group consisting of silicon (Si) and aluminum (Al). The first dielectric layer may contain, for example, one or two or more of SiO₂, Al₂O₃, and the like. When the first dielectric layer contains two or more first metal oxides, the oxides may be mixed or arranged in layers respectively.

The first dielectric layer contains the first metal and is substantially free of a second metal. The wording “substantially free of a second metal” means that the amount of second metal is below the detection limit in energy dispersive X-ray spectroscopy (EDX) analysis.

### (Second Dielectric Layer)

The second dielectric layer contains a second metal oxide (hereinafter also referred to as a “second oxide”) with a higher dielectric constant than the first metal oxide. The second oxide contains a second metal that is different from the first metal. The second metal oxide has a higher dielectric constant than the first metal oxide. From the viewpoint of increasing the capacitance, the second metal is preferably at least one selected from the group consisting of tantalum (Ta), titanium (Ti), zirconium (Zr), niobium (Nb), and hafnium (Hf). The second dielectric layer contains, for example, one or two or more of Ta₂O₅, TiO₂, ZrO₂, Nb₂O₅, HfO₂, and the like. When the second dielectric layer contains two or more second metal oxides, the two or more oxides may be mixed or arranged in layers respectively.

The second oxide may contain the first metal (e.g., at least one selected from the group consisting of silicon and aluminum) together with the second metal. That is to say, the second oxide may be a composite oxide in which the first metal oxide and the second metal oxide are mixed. When the second metal oxide tends to crystallize and have a large LC, it is possible to suppress crystallization and to easily obtain the effect of suppressing an increase in LC by making the second metal oxide a composite oxide. When the second metal is Ti, the effect of making it a composite oxide is particularly remarkable. For example, when the second dielectric layer is a composite oxide layer in which TiO₂ and Al₂O₃ are mixed, the molar ratio Ti/Al in the composite oxide layer may be, for example, 2 or more and 6 or less.

The first dielectric layer and the second dielectric layer can be identified as follows. That is, a cross-sectional image of an electrode foil in the thickness direction (a cross-sectional image including a porous portion) is obtained using a scanning electron microscope (SEM) or a transmission electron microscope (TEM), and elemental mapping is performed using the image through energy dispersive X-ray spectroscopy (EDX) analysis to obtain a map of the first metal and the second metal in the metal oxide layer that covers the surface of the anode body. The above image is used to distinguish between a region of a metal structure constituting the anode body and a region of a metal oxide constituting the first dielectric layer and the second dielectric layer. For example, these two regions can be distinguished by the binarization process of the image. In the elemental mapping, a region in which the second metal is distributed in the region of the metal oxide is identified as the second dielectric layer. Also, a region in which the first metal is distributed and the second metal is not distributed (the amount of second metal is below the detection limit) between the anode body and the second dielectric layer in the region of the metal oxide is identified as the first dielectric layer.

The thickness T2 of the second dielectric layer is greater than the thickness T1 of the first dielectric layer. T1/T2 may be, for example, 0.6 or less, 0.3 or less, or 0.1 or less. This ensures that the second dielectric layer with a high dielectric constant is sufficiently obtained, and thus the capacitance can be increased. The thickness T1 of the first dielectric layer is obtained by measuring the thickness at any 10 points of the first dielectric layer identified through the above-described elemental mapping of the cross-sectional image of the electrode foil in the thickness direction and calculating the average value thereof. The thickness T2 of the second dielectric layer is also obtained in the same manner as the thickness T1 of the first dielectric layer.

From the viewpoint of sufficiently suppressing oxygen migration from the second dielectric layer to the anode body, the thickness T1 of the first dielectric layer may be 0.3 nm or more.

From the viewpoint of easily realizing a low LC by the first dielectric layer and a large capacitance by the second dielectric layer at the same time, when the first metal contains Si, a ratio T1/T2 of the thickness T1 of the first dielectric layer to the thickness T2 of the second dielectric layer may be 0.45 or less, 0.2 or less, or 0.1 or less. From a similar viewpoint, when the first metal contains Al, T1/T2 may be 0.6 or less, 0.25 or less, or 0.1 or less. When T1/T2 is within the above-mentioned range, an electrolytic capacitor with a large CV value and less LC can be easily obtained.

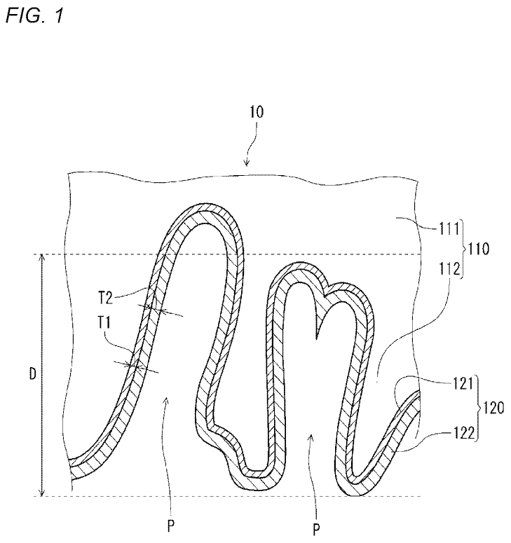

Hereinafter, an example of an electrode foil according to an embodiment of the present disclosure will be described with reference to FIG. 1. FIG. 1 is a cross-sectional view schematically showing the surface portion of an electrode foil according to an embodiment of the present disclosure.

An anode foil 10 (electrode foil) includes an anode body 110 and a dielectric layer 120 that covers at least a part of the anode body 110. The dielectric layer 120 includes a first dielectric layer 121 that covers at least a part of the anode body 110 and a second dielectric layer 122 that covers at least a part of the first dielectric layer 121. The second dielectric layer 122 has a higher dielectric constant than the first dielectric layer 121. The thickness T2 of the second dielectric layer 122 is greater than the thickness T1 of the first dielectric layer 121.

The anode body 110 is a metal foil containing a valve action metal and having a surface roughened by etching or the like, and includes a core portion 111 and a porous portion 112. The porous portion 112 has a large number of pits P. The dielectric layer 120 (the first dielectric layer 121 and the second dielectric layer 122) covers the outer surface of the porous portion 112 and the inner wall faces of the pits P.

### [Method for Producing Electrode Foil for Electrolytic Capacitor]

A method for producing an electrode foil for an electrolytic capacitor according to an embodiment of the present disclosure includes: a first step of preparing an anode body that contains a valve action metal; a second step of forming a first dielectric layer that covers at least a part of the anode body; and a third step of forming a second dielectric layer that covers at least a part of the first dielectric layer, after the second step. The second dielectric layer has a higher dielectric constant than the first dielectric layer. The thickness T2 of the second dielectric layer is greater than the thickness T1 of the first dielectric layer. The first dielectric layer is a layer that suppresses oxygen diffusion from the second dielectric layer to the anode body. Hereinafter, each of the steps will be described in detail.

### (First Step)

An anode body contains a valve action metal such as tantalum, niobium, titanium, or aluminum. The anode body is, for example, a metal foil with a surface roughened by etching or the like. The thickness of the metal foil is, for example, 15 μm or more and 300 μm or less.

A metal foil with a roughened surface includes a porous portion and a core portion that is continuous with the porous portion. The porous portion has a large number of pits. There is no particular limitation on a modal pore size of the pits of the porous portion, but it is, for example, 50 nm or more and 2000 nm or less from the viewpoint of easily obtaining a large surface area and forming a dielectric layer in the depth of the pits. The modal pore size of the pits is a modal pore size in the volume-based pore size distribution measured by a mercury porosimeter. There is no particular limitation on a thickness D per side of the porous portion, but it is, for example, 1/10 or more and 4/10 or less of the total thickness of the metal foil from the viewpoint of ensuring a large surface area and maintaining the strength of the electrode foil. The thickness D per side of the porous portion is obtained by measuring the thickness at any 10 points using a cross-sectional image of the metal foil with a SEM or TEM and calculating the average value thereof.

### (Second Step)

In the second step, a first dielectric layer may be formed through atomic layer deposition (ALD) or chemical conversion treatment. In the case of chemical conversion treatment, a layer of an oxide of a valve action metal is formed as the first dielectric layer, and the valve action metal serves as the first metal. In the case of ALD, the first metal can be selected as appropriate, independent of the valve action metal contained in the anode body. The chemical conversion treatment is performed, for example, by immersing the anode body in a chemical liquid such as an ammonium adipate solution and applying a predetermined formation voltage (anodic oxidation). In the case of chemical conversion treatment, the thickness T1 of the first dielectric layer can be controlled by the formation voltage and the like.

In the case of ALD, the first dielectric layer can be formed on the surface of an object by alternately supplying a raw material gas containing the first metal and an oxidant to a reaction chamber in which the object is placed. In the ALD, the first metal is deposited on the surface of the object in atomic layers because of the self-limiting effect. Therefore, it is easy to control the thickness T1 of the first dielectric layer by adjusting the number of cycles, where one cycle is set to supply of a raw material gas→exhaust (purge) of the raw material gas→supply of an oxidant→exhaust (purge) of the oxidant.

Examples of the oxidant include water, oxygen, and ozone. The oxidant may be supplied to the reaction chamber as plasma generated from the oxidant.

The first metal is supplied to the reaction chamber as a precursor gas (raw material gas) containing the first metal. The precursor is, for example, an organometallic compound containing the first metal, which facilitates chemisorption of the first metal onto the object. Various organometallic compounds conventionally used in ALD can be used as the precursor. Examples of a precursor containing the first metal include Al-containing precursors and Si-containing precursors. Examples of the Al-containing precursors include trimethylaluminum ((CH₃)₃Al).

Examples of the Si-containing precursors include N-sec-butyl (trimethylsilyl) amine (C₇H₁₉NSi), 1,3-diethyl-1,1,3,3-tetramethyldisilazane (C₈H₂₃NSi₂), 2,4,6,8,10-pentamethylcyclopentasiloxane ((CH₃SiHO)₅), pentamethyldisilane ((CH₃)₃SiSi(CH₃)₂H), tris(dimethylamino)silane ([(CH₃)₂N]₃SiH), tris(isopropoxy)silanol ([(H₃C)₂CHO]₃SiOH), chloropentanemethyldisilane ((CH₃)₃SiSi(CH₃)₂Cl), dichlorosilane (SiH₂Cl₂), tridimethylaminosilane (Si[N(CH₃)₂]₄), tetraethylsilane (Si(C₂H₅)₄), tetramethylsilane (Si(CH₃)₄), tetraethoxysilane (Si(OC₂H₅)₄), dodecamethylcyclohexasilane ((Si(CH₃)₂)₆), silicon tetrachloride (SiCl₄), and silicon tetrabromide (SiBr₄).

These first metals may be used alone or in a combination with two or more. When using a combination of two or more first metals, a precursor containing the two or more first metals may be used. In this case, the type of first metal to be deposited in atomic layers may be changed layer by layer by changing the type of precursor to be supplied to the reaction chamber according to the cycle. In this case, a first dielectric layer (a composite oxide layer) in which two or more first metal oxides are mixed can be formed.

### (Third Step)

In the third step, a second dielectric layer is preferably formed through ALD in the same manner as described above. The second metal can be selected as appropriate for the first metal, and the thickness T2 of the second dielectric layer can be easily controlled by the number of cycles. In the step of forming a second dielectric layer through ALD, the second metal is supplied to the reaction chamber as a precursor gas (raw material gas) containing the second metal. Examples of a precursor containing the second metal include Ta-containing precursors, Ti-containing precursors, Zr-containing precursors, Nb-containing precursors, and Hf-containing precursors.

Examples of the Ta-containing precursors include tris(ethylmethylamido)(t-butylamido)tantalum(V) (C₁₃H₃₃N₄Ta), tantalum(V) ethoxide (Ta(OC₂H₅)₅), tris(diethylamido)(t-butylimido)tantalum(V) ((CH₃)₃CNTa(N(C₂H₅)₂)₃), and pentakis(dimethylamino)tantalum(V) (Ta(N(CH₃)₂)₅).

Examples of the Ti-containing precursors include bis(t-butylcyclopentadienyl)titanium(IV) dichloride (C₁₈H₂₆Cl₂Ti), tetrakis(dimethylamino)titanium(IV) ([(CH₃)₂N]₄Ti), tetrakis(diethylamino)titanium(IV) ([(C₂H₅)₂N]₄Ti), tetrakis(ethylmethylamino)titanium(IV) (Ti[N(C₂H₅)(CH₃)]₄), titanium(IV) (diisopropoxide-bis(2,2,6,6-tetramethyl-3,5-heptanedionate)) (Ti[OCC(CH₃)₃CHCOC(CH₃)₃]₂(OC₃H₇)₂), titanium tetrachloride (TiCl₄), titanium(IV) isopropoxide (Ti[OCH(CH₃)₂]₄), and titanium(IV) ethoxide (Ti[O(C₂H₅)]₄).

Examples of the Zr-containing precursors include bis(methyl-η⁵-cyclopentadienyl)methoxymethylzirconium (Zr(CH₃CH₄)₂CH₃OCH₃), tetrakis(dimethylamido)zirconium(IV) ([(CH₃)₂N]₄Zr), tetrakis(ethylmethylamido)zirconium(IV) (Zr(NCH₃C₂H₅)₄), and zirconium(IV) t-butoxide (Zr[OC(CH₃)₃]₄).

Examples of the Nb-containing precursors include niobium(V) ethoxide (Nb(OCH₂CH₃)₅, and tris(diethylamido)(t-butylimido)niobium(V) (C₁₆H₃₉N₄Nb).

Examples of the Hf-containing precursors include hafnium tetrachloride (HfCl₄), tetrakis dimethylamino hafnium (Hf[N(CH₃)₂]₄), tetrakis ethylmethylamino hafnium (Hf[N(C₂H₅)(CH₃)]₄), tetrakis diethylamino hafnium (Hf[N(C₂H₅)₂]₄), and hafnium-t-butoxide (Hf[OC(CH₃)₃]₄).

These second metals may be used alone or in a combination with two or more. When using a combination of two or more second metals, a precursor containing the two or more second metals may be used. In this case, the type of second metal to be deposited in atomic layers may be changed layer by layer by changing the type of precursor to be supplied to the reaction chamber according to the cycle. In this case, a second dielectric layer (a composite oxide layer) in which two or more second metal oxides are mixed can be formed.

The first metal may also be used together with the second metal. In this case, a precursor containing the first metal and the second metal may be used. In this case, the type of metal to be deposited in atomic layers may be changed layer by layer by changing the type of precursor to be supplied to the reaction chamber according to the cycle. In this case, a second dielectric layer (a composite oxide layer) in which the first metal oxide and the second metal oxide are mixed can be formed. In the case of ALD, the mixing ratio between the first metal oxide and the second metal oxide in the composite oxide layer is easily controlled.

The step of forming a second dielectric layer (third step) is performed after the step of forming a first dielectric layer (second step). In this case, the first dielectric layer functions as a suppression layer with respect to the second dielectric layer. When the first dielectric layer with the thickness T1 functions as a suppression layer with respect to the second dielectric layer with the thickness T2, the LC value can be reduced to ½ or less, for example, compared to the case where the dielectric layer whose thickness is the sum of T1 and T2 is constituted only by the second dielectric layer.

If a chemical conversion film is formed as the first dielectric layer between the anode body and the second dielectric layer by performing chemical conversion treatment after forming the second dielectric layer, the first dielectric layer does not function as a suppression layer. In this case, the chemical conversion treatment performed to form the first dielectric layer reduces the insulation of the second dielectric layer and increases the LC value.

### [Electrolytic Capacitor]

An electrolytic capacitor according to an embodiment of the present disclosure includes the above-described electrode foil for an electrolytic capacitor and a cathode portion that covers at least a part of the second dielectric layer. Hereinafter, the above-described electrode foil for an electrolytic capacitor and the cathode portion are also collectively referred to as a “capacitor element”. The cathode portion contains an electrolyte. The electrolyte covers at least a part of the second dielectric layer. The electrolyte contains at least one of a solid electrolyte and an electrolyte solution. The cathode portion may contain a solid electrolyte and an electrolyte solution, or may contain a solid electrolyte and a solvent (e.g., a polyol compound).

The solid electrolyte contains a conductive polymer. The conductive polymer is a x-conjugated polymer, for example. Examples of the conductive polymer include polypyrrole, polythiophene, polyfuran, and polyaniline. It is possible to use one type of conductive polymer alone, two or more types of conductive polymers in combination, or a copolymer of two or more monomers. The conductive polymer has a weight-average molecular weight of 1000 to 100000, for example.

Note that polypyrrole, polythiophene, polyfuran, polyaniline, and the like referred to in the present specification respectively mean polymers that include polypyrrole, polythiophene, polyfuran, polyaniline, and the like as the basic structure. Accordingly, the terms polypyrrole, polythiophene, polyfuran, polyaniline, and the like also encompass derivatives of those polymers. For example, the term polythiophene encompasses poly (3,4-ethylenedioxythiophene) (PEDOT), for example.

The conductive polymer may be doped with a dopant. Examples of the dopant include polystyrene sulfonic acid (PSS). The solid electrolyte may further contain an additive as necessary.

The electrolyte solution contains a solvent and an ionic material (a solute (e.g., an organic salt)) dissolved therein. The solvent may be an organic solvent or an ionic liquid. A solvent that has a high boiling point is preferably used as the solvent. For example, it is possible to use polyol compounds such as ethylene glycol, sulfone compounds such as sulfolane, lactone compounds such as γ-butyrolactone, ester compounds such as methyl acetate, carbonate compounds such as propylene carbonate, ether compounds such as 1,4-dioxane, and ketone compounds such as methylethylketone. These solvents may be used alone or in a combination with two or more.

An organic salt is a salt in which at least one of the anion and the cation includes an organic substance. Examples of organic salts that can be used include trimethylamine maleate, triethylamine borodisalicylate, ethyldimethylamine phthalate, mono-1,2,3,4-tetramethylimidazolinium phthalate, and mono-1,3-dimethyl-2-ethylimidazolinium phthalate. These organic salts may be used alone or in a combination with two or more.

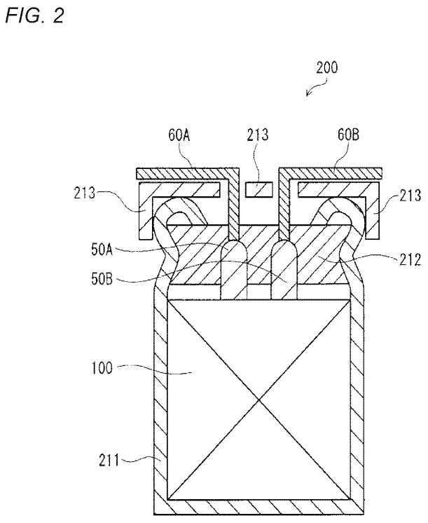

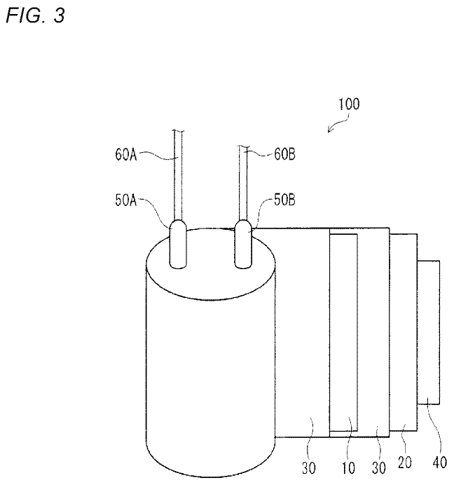

FIG. 2 is a cross-sectional view schematically showing the electrolytic capacitor according to an embodiment of the present disclosure. FIG. 3 is a perspective view showing a wound body that has been partially unwound.

A wound-type electrolytic capacitor 200 includes a capacitor element. The capacitor element includes a wound body 100 and an electrolyte (not shown). The wound body 100 is obtained by winding together the anode foil 10 and a cathode foil 20 with a separator 30 interposed therebetween. The anode foil 10 is the electrode foil for an electrolytic capacitor according to the present disclosure. There is no particular limitation on the separator 30, and it may be, for example, a non-woven fabric containing cellulose, polyethylene terephthalate, vinylon, or polyamide fibers.

End portions of lead tabs 50A and 50B are respectively connected to the anode foil 10 and the cathode foil 20, and the wound body 100 is obtained by winding the electrode foils to which the lead tabs 50A and 50B are connected. Lead wires 60A and 60B are respectively connected to other end portions of the lead tabs 50A and 50B.

A winding end tape 40 is provided on the outer surface of a portion of the cathode foil 20 constituting the outermost layer of the wound body 100, and an end portion of the cathode foil 20 is fixed with the winding end tape 40. If the anode foil 10 is prepared by cutting a large foil, chemical conversion treatment may be further performed on the wound body 100 to provide a dielectric layer on the cut surface.

An electrolyte is contained in the wound body 100 and is interposed between the anode foil 10 and the cathode foil 20 in the wound body 100. A wound body containing the electrolyte is obtained by impregnating the wound body with a treatment solution containing a conductive polymer (or the electrolyte solution), for example. The impregnation may be carried out in an atmosphere having a reduced pressure of 10 kPa to 100 kPa, for example.

The wound body 100 is housed in a bottomed case 211 such that the lead wires 60A and 60B are located on the opening side of the bottomed case 211. The bottomed case 211 may be made of metal such as aluminum, stainless steel, copper, iron, or brass, or an alloy of any of these metals.

A sealing member 212 is arranged in the opening of the bottomed case 211 in which the wound body 100 is housed, the open end of the bottomed case 211 is swaged on the sealing member 212 to be curled, and a base plate 213 is arranged on the curled portion to seal the wound body 100 in the bottomed case 211.

The sealing member 212 is formed such that the lead wires 60A and 60B extend therethrough. The sealing member 212 is only required to be made of an insulating material, and is preferably constituted of an elastic member. In particular, it is preferable to use silicone rubber, fluororubber, ethylene propylene rubber, Hypalon rubber, butyl rubber, isoprene rubber, or the like, which has high heat resistance.

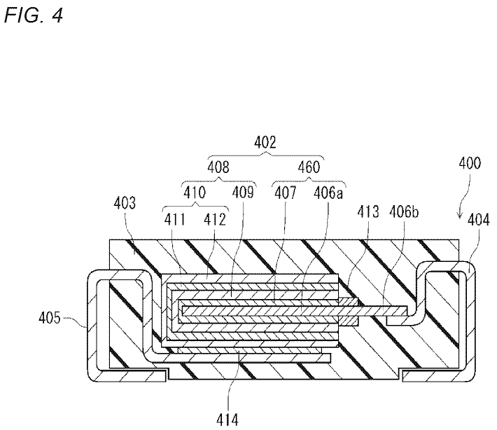

FIG. 4 is a cross-sectional view schematically showing an electrolytic capacitor according to another embodiment of the present disclosure.

A laminated-type electrolytic capacitor 400 includes a capacitor element 402, an anode lead terminal 404 and a cathode lead terminal 405 that are electrically connected to the capacitor element 402, and a resin outer body 403 that seals the capacitor element 402. Portions of the anode lead terminal 404 and the cathode lead terminal 405 are covered with the outer body 403. The outer body 403 has a substantially rectangular parallelepiped outer shape, and the electrolytic capacitor 400 also has a substantially rectangular parallelepiped outer shape.

The capacitor element 402 includes an anode body (a metal foil containing a valve action metal) that has a cathode forming portion 406a and an anode extraction portion 406b, a dielectric layer 407 that covers the cathode forming portion 406a, and a cathode portion 408 that covers the dielectric layer 407. The anode body has a porous portion on its surface, and the dielectric layer 407 is formed to cover the surface of the porous portion of the cathode forming portion 406a. An anode foil 460 is constituted by the cathode forming portion 406a and the dielectric layer 407 of the anode body. The anode foil 460 is the electrode foil for an electrolytic capacitor according to the present disclosure.

An insulating separation layer 413 is formed in a part of the anode extraction portion 406b that is adjacent to the cathode portion 408, thus restricting contact between the cathode portion 408 and the anode foil 460. The anode extraction portion 406b and the anode lead terminal 404 are electrically connected to each other through welding. The cathode lead terminal 405 is electrically connected to the cathode portion 408 via an adhesive layer 414 made of a conductive adhesive.

The cathode portion 408 includes a solid electrolyte layer 409 that covers the dielectric layer 407 and a cathode extraction layer 410 that covers the solid electrolyte layer 409. The solid electrolyte layer 409 contains a conductive polymer and may further contain a dopant or the like as necessary. The solid electrolyte layer 409 can be formed by, for example, impregnating the anode foil 460 with a treatment solution containing a conductive polymer.

The cathode extraction layer 410 includes a carbon layer 411 and a silver paste layer 412. The carbon layer 411 contains, for example, carbon particles and silver. The silver paste layer 412 contains, for example, silver particles and a binder. There is no particular limitation on the binder, and a product obtained by curing a curable resin is preferable. Examples of the curable resin include thermosetting resins such as epoxy resins.

The outer body 403 preferably contains a product obtained by curing a curable resin composition, and may contain a thermoplastic resin or a composition containing the same. Examples of the curable resin include thermosetting resins such as epoxy resins.

The anode body may be a porous sintered body with a roughened surface obtained by sintering particles containing a valve action metal, instead of the metal foil containing a valve action metal. Portions of the metal lead members are embedded in the porous sintered body.

### EXAMPLES

Although the present disclosure will be described below in more detail using Examples, the present disclosure is not limited to the examples.

### Examples 1 to 3 and Comparative Example 7

A wound-type electrolytic capacitor (diameter Φ 6.3 mm×length L 9.9 mm) with a rated voltage of 2.0 V was produced. Hereinafter, a specific method for producing the electrolytic capacitor will be described.

### (Production of Anode Foil)

### (First Step: Production of Anode Body)

An Al foil with a thickness of 120 μm was prepared, and the surface of the Al foil was roughened by etching to form a porous portion (thickness of 40 μm per side, pore size of 100 to 200 nm for pits). In this manner, an anode body was obtained.

### (Second Step: Formation of First Dielectric Layer)

A first dielectric layer (a layer of the first metal oxide) was formed on the surface of the anode body through ALD (temperature: 150° C., precursor: Si-containing precursor, oxidant: O₃, pressure: 1 Pa). An Si oxide (SiOₓ) layer was formed as the first dielectric layer, using tridimethylaminosilane as the Si-containing precursor. The number of cycles was adjusted as appropriate to set the thickness T1 of the first dielectric layer to a value shown in Table 1.

### (Third Step: Formation of Second Dielectric Layer)

A second dielectric layer (a layer of the second metal oxide) was formed on the surface of the first dielectric layer through ALD (temperature: 150° C., precursor: Ti-containing precursor and Al-containing precursor, oxidant: H₂O, pressure: 1 Pa).

Tetrakis (dimethylamino) titanium (IV) was used as the Ti-containing precursor, and trimethylaluminum was used as the Al-containing precursor. One set was set to include six cycles in which the Ti-containing precursor was supplied in five cycles and the Al-containing precursor was supplied in one cycle. In this manner, a composite oxide layer (Ti—Al—Oₓ) was formed in which TiO₂ and Al₂O₃ were mixed at a molar ratio of 5:1. The number of cycles (the number of sets) was adjusted as appropriate to set the thickness T2 of the second dielectric layer to a value shown in Table 1. In this manner, an anode foil was obtained. The anode foil was then cut to a specified size.

The first dielectric layer and the second dielectric layer were identified by the previously described method. The thickness T1 of the first dielectric layer and the thickness T2 of the second dielectric layer shown in Table 1 were obtained by the previously described method.

### (Production of Cathode Foil)

An Al foil with a thickness of 50 μm was subjected to etching to roughen the surface of the Al foil, and thus a cathode foil was obtained. The cathode foil was then cut to a specified size.

### (Production of Wound Body)

An anode lead tab and a cathode lead tab were connected to the anode foil and the cathode foil, and the anode foil and the cathode foil to which the lead tabs were connected were wound with a separator interposed therebetween. An anode lead wire and a cathode lead wire were respectively connected to end portions of the lead tabs projecting from the wound body.

Then, the produced wound body was subjected to chemical conversion treatment to form a chemical conversion film (a dielectric layer) on the cut end portion of the anode foil. The chemical conversion treatment was performed using an ammonium adipate solution (concentration 7% by mass, temperature 70° C.) as the chemical liquid at a formation voltage Vf of 8.5 V. Next, the end portion of the outer surface of the wound body was fixed with a winding end tape.

### (Preparation of Conductive Polymer Dispersion)

A mixed solution was prepared by dissolving 3,4-ethylenedioxythiophene and polystyrenesulfonic acid as a dopant in ion-exchanged water. Iron (III) sulfate (oxidant) dissolved in ion-exchanged water was added to the resulting mixed solution while stirring, and a polymerization reaction was carried out. After the reaction, the resulting reaction solution was dialyzed to remove unreacted monomers and excess oxidant to obtain a conductive polymer dispersion containing polyethylenedioxythiophene doped with about 5% by mass of polystyrenesulfonic acid.

### (Formation of Solid Electrolyte Layer)

The wound body was immersed in the conductive polymer dispersion contained in a predetermined container for 5 minutes in a reduced pressure atmosphere (40 kPa), and then the wound body was pulled up from the conductive polymer dispersion. Next, the wound body impregnated with the conductive polymer dispersion was dried in a drying oven at 150° C. for 20 minutes to form a solid electrolyte layer containing the conductive polymer between the anode foil and the cathode foil. In this manner, a capacitor element was obtained.

### (Sealing of Capacitor Element)

The capacitor element was housed in a bottomed case, and the capacitor element was sealed using a sealing member and a base plate to complete an electrolytic capacitor. Subsequently, aging treatment was performed at 130° C. for 2 hours while the rated voltage was applied. A1 to A3 in Table 1 are the electrolytic capacitors of Examples 1 to 3, respectively. X7 in Table 1 is the electrolytic capacitor of Comparative Example 7.

### Examples 4 and 5 and Comparative Example 8

### (Formation of First Dielectric Layer)

A first dielectric layer (a layer of the first metal oxide) was formed on the surface of the anode body through ALD (temperature: 150° C., precursor: Al-containing precursor, oxidant: H₂O, pressure: 1 Pa). An Al oxide (AlOₓ) layer was formed as the first dielectric layer, using trimethylaluminum as the Al-containing precursor. The number of cycles was adjusted as appropriate to set the thickness T1 of the first dielectric layer to a value shown in Table 1.

### (Formation of Second Dielectric Layer)

A second dielectric layer (a layer of the second metal oxide) was formed on the surface of the first dielectric layer through ALD (temperature: 150° C., precursor: Ti-containing precursor and Al-containing precursor, oxidant: H₂O, pressure: 1 Pa).

Tetrakis (dimethylamino) titanium (IV) was used as the Ti-containing precursor, and trimethylaluminum was used as the Al-containing precursor. One set was set to include six cycles in which the Ti-containing precursor was supplied in five cycles and the Al-containing precursor was supplied in one cycle. In this manner, a composite oxide layer (Ti—Al—Oₓ) was formed in which TiO₂ and Al₂O₃ were mixed at a molar ratio of 5:1. The number of cycles (the number of sets) was adjusted as appropriate to set the thickness T2 of the second dielectric layer to a value shown in Table 1.

Electrolytic capacitors B1 and B2 of Examples 4 and 5 and an electrolytic capacitor X8 of Comparative Example 8 were produced in the same way as that of the electrolytic capacitor A1 of Example 1, except for the above.

### Comparative Example 1

A second dielectric layer was formed on the surface of the anode body without forming the first dielectric layer. As the second dielectric layer, a Ti oxide (TiOₓ) layer was formed through ALD (temperature: 150° C., precursor: tetrakis (dimethylamino) titanium (IV), oxidant: H₂O, pressure: 1 Pa). The number of cycles was adjusted as appropriate to set the thickness of the second dielectric layer to a value shown in Table 1. An electrolytic capacitor X1 was produced in the same way as that of the electrolytic capacitor A1 of Example 1, except for the above.

### Comparative Example 2

A second dielectric layer was formed on the surface of the anode body without forming the first dielectric layer. The number of cycles was adjusted as appropriate to set the thickness of the second dielectric layer to a value shown in Table 1. An electrolytic capacitor X2 was produced in the same way as that of the electrolytic capacitor A1 of Example 1, except for the above.

### Comparative Example 3

### (Formation of Second Dielectric Layer)

A second dielectric layer was formed on the surface of the anode body through ALD (temperature: 150° C., precursor: Ti-containing precursor and Al-containing precursor, oxidant: H₂O, pressure: 1 Pa).

Tetrakis (dimethylamino) titanium (IV) was used as the Ti-containing precursor, and trimethylaluminum was used as the Al-containing precursor. One set was set to include 12 cycles in which the Ti-containing precursor was supplied in 11 cycles and the Al-containing precursor was supplied in one cycle. In this manner, a composite oxide layer (Ti—Al—Oₓ) was formed in which TiO₂ and Al₂O₃ were mixed at a molar ratio of 11:1, as the second dielectric layer. The number of cycles (the number of sets) was adjusted as appropriate to set the thickness T2 of the second dielectric layer to a value shown in Table 1.

### (Formation of First Dielectric Layer)

The anode body having the second dielectric layer on its surface was subjected to chemical conversion treatment to form a chemical conversion film (AlOₓ) layer as the first dielectric layer between the anode body and the second dielectric layer. An ammonium adipate solution (concentration 7% by mass, temperature 70° C.) was used as the chemical liquid. The formation voltage Vf was adjusted as appropriate to set the thickness T1 of the first dielectric layer (chemical conversion film) to a value shown in Table 1.

An electrolytic capacitor X3 of Comparative Example 3 was produced in the same way as that of the electrolytic capacitor A1 of Example 1, except for the above.

### Comparative Example 4

### (Formation of Second Dielectric Layer)

A second dielectric layer was formed on the surface of the anode body through ALD (temperature: 150° C., precursor: Ti-containing precursor and Al-containing precursor, oxidant: H₂O, pressure: 1 Pa).

Tetrakis (dimethylamino) titanium (IV) was used as the Ti-containing precursor, and trimethylaluminum was used as the Al-containing precursor. One set was set to include six cycles in which the Ti-containing precursor was supplied in five cycles and the Al-containing precursor was supplied in one cycle. In this manner, a composite oxide layer (Ti—Al—Oₓ) was formed in which TiO₂ and Al₂O₃ were mixed at a molar ratio of 5:1, as the second dielectric layer. The number of cycles (the number of sets) was adjusted as appropriate to set the thickness T2 of the second dielectric layer to a value shown in Table 1.

### (Formation of First Dielectric Layer)

The anode body having the second dielectric layer on its surface was subjected to chemical conversion treatment to form a chemical conversion film (AlOₓ) layer as the first dielectric layer between the anode body and the second dielectric layer. An ammonium adipate solution (concentration 7% by mass, temperature 70° C.) was used as the chemical liquid. The formation voltage Vf was adjusted as appropriate to set the thickness T1 of the first dielectric layer (chemical conversion film) to a value shown in Table 1.

An electrolytic capacitor X4 of Comparative Example 4 was produced in the same way as that of the electrolytic capacitor A1 of Example 1, except for the above.

### Comparative Example 5

### (Formation of First Dielectric Layer)

A first dielectric layer was formed on the surface of the anode body through ALD (temperature: 150° C., precursor: Ti-containing precursor and Al-containing precursor, oxidant: H₂O, pressure: 1 Pa).

Tetrakis(dimethylamino)titanium(IV) was used as the Ti-containing precursor, and trimethylaluminum was used as the Al-containing precursor. One set was set to include six cycles in which the Ti-containing precursor was supplied in five cycles and the Al-containing precursor was supplied in one cycle. In this manner, a composite oxide layer (Ti—Al—Oₓ) was formed in which TiO₂ and Al₂O₃ were mixed at a molar ratio of 5:1, as the first dielectric layer. The number of cycles (the number of sets) was adjusted as appropriate to set the thickness T1 of the first dielectric layer to a value shown in Table 1.

### (Formation of Second Dielectric Layer)

A Si oxide (SiOₓ) layer was formed as the second dielectric layer on the surface of the first dielectric layer through ALD (temperature: 150° C., precursor: Si-containing precursor, oxidant: O₃, pressure: 1 Pa). Tridimethylaminosilane was used as the Si-containing precursor. The number of cycles was adjusted as appropriate to set the thickness T2 of the second dielectric layer to a value shown in Table 1.

An electrolytic capacitor X5 of Comparative Example 5 was produced in the same way as that of the electrolytic capacitor A1 of Example 1, except for the above.

### Comparative Example 6

The anode body was subjected to chemical conversion treatment to form a chemical conversion film (AlOₓ) layer as the first dielectric layer on the surface of the anode body. The chemical conversion treatment was performed by immersing the anode body in an ammonium adipate solution and applying the formation voltage Vf to the anode body. The formation voltage Vf was adjusted as appropriate to set the thickness T1 of the first dielectric layer (chemical conversion film) to a value shown in Table 1. The second dielectric layer was not formed.

An electrolytic capacitor X6 of Comparative Example 6 was produced in the same way as that of the electrolytic capacitor A1 of Example 1, except for the above.

### [Evaluation]

The breakdown withstand voltage, the capacitance, and the leakage current of the electrolytic capacitors of the examples and the comparative examples were measured at 20° C. Specifically, the breakdown withstand voltage at which an overcurrent of 0.5 A flowed was measured while applying a voltage and increasing the voltage at a rate of 1.0 V/sec. The capacitance at a frequency of 120 Hz was measured using an LCR meter for 4-terminal measurement. The current flowing through the electrolytic capacitor was measured when held at the rated voltage for 40 seconds, and the current value was defined as the leakage current.

The capacitance is represented as an index (a capacitance index C) with the capacitance of the electrolytic capacitor X6 of Comparative Example 6 set to 100. The breakdown withstand voltage is represented as an index (a withstand voltage index V) with the breakdown withstand voltage of the electrolytic capacitor X6 of Comparative Example 6 set to 100. The leakage current is represented as an index (an LC index) with the leakage current of the electrolytic capacitor X6 of Comparative Example 6 set to 100.

Table 1 shows the evaluation results. Table 1 also shows CV values. The CV values are values obtained by multiplying the capacitance by the breakdown withstand voltage, and indicate the amount of electricity that the electrolytic capacitor can store. The CV values are each represented as an index (a CV index) with the CV value of the electrolytic capacitor X6 of Comparative Example 6 set to 100.

TABLE 1

| | | First dielectric layer | | Second dielectric layer | | | | | | | |
|---|---|---|---|---|---|---|---|---|---|---|---|
| | | First | Thickness | Second | Ti/Al | Thickness | | | Withstand | CV | |
| Electrolytic | Step of forming | metal | T1 | metal | molar | T2 | | Capacitance | voltage | index | LC |
| capacitor | first dielectric layer | oxide | (nm) | oxide | ratio | (nm) | T1/T2 | index C | index V | (C × V) | index |
| A1 | Formed on surface | SiOₓ | 0.5 | Ti-Al-Oₓ | 2-May | 14 | 0.04 | 152 | 100 | 152 | 85 |
| A2 | of anode body | SiOₓ | 1 | Ti-Al-Oₓ | 2-May | 14 | 0.07 | 145 | 100 | 145 | 80 |
| A3 | through ALD | SiOₓ | 2.2 | Ti-Al-Oₓ | 2-May | 4.9 | 0.45 | 122 | 100 | 122 | 80 |
| X7 | | SiOₓ | 2.8 | Ti-Al-Oₓ | 2-May | 2.3 | 1.2 | 113 | 100 | 113 | 80 |
| B1 | Formed on surface | AlOₓ | 0.5 | Ti-Al-Oₓ | 2-May | 14 | 0.04 | 151 | 100 | 151 | 100 |
| B2 | of anode body | AlOₓ | 4.5 | Ti-Al-Oₓ | 2-May | 7.5 | 0.6 | 120 | 100 | 120 | 100 |
| X8 | through ALD | AlOₓ | 6.5 | Ti-Al-Oₓ | 2-May | 5.5 | 1.2 | 108 | 100 | 108 | 100 |
| X1 | — | — | — | TiOₓ | — | 16 | — | 250 | 73 | 182 | 213 |
| X2 | — | — | — | Ti-Al-Oₓ | 2-May | 14 | — | 162 | 85 | 138 | 191 |
| X3 | Formed through | AlOₓ | 2.8 | Ti-Al-Oₓ | 2-Nov. | 12 | 0.24 | 151 | 80 | 121 | 200 |
| X4 | chemical conversion | AlOₓ | 5.5 | Ti-Al-Oₓ | 2-May | 8 | 0.68 | 130 | 82 | 107 | 161 |
| | treatment after | | | | | | | | | | |
| | formation of second | | | | | | | | | | |
| | dielectric layer | | | | | | | | | | |
| X5 | Formed on surface | Ti-Al- | 14 | SiOₓ | — | 0.5 | 28 | 151 | 84 | 127 | 185 |
| | of anode body | Oₓ | | | | | | | | | |
| | through ALD | | | | | | | | | | |
| X6 | Formed on surface | AlOₓ | 15 | — | — | — | — | 100 | 100 | 100 | 100 |
| | of anode body | | | | | | | | | | |
| | through chemical | | | | | | | | | | |
| | conversion treatment | | | | | | | | | | |

In the electrolytic capacitors A1 to A3 and B1 and B2, an increase in the LC was suppressed while increasing the capacitance, that is, large capacitance and low LC were achieved at the same time. In the electrolytic capacitors A1 to A3 and B1 and B2, a decrease in the withstand voltage index V was suppressed as well. In the electrolytic capacitors X1 to X8, large capacitance and low LC were not achieved at the same time.

In the electrolytic capacitors X1 and X2, the first dielectric layer was not formed, and thus the chemical conversion treatment performed on the wound body reduced the insulation of the second dielectric layer, increased the LC index, and lowered the withstand voltage index V.

In the electrolytic capacitors X3 and X4, the first dielectric layer was formed through chemical conversion treatment after forming the second dielectric layer, and thus the first dielectric layer did not function as a suppression layer, and the chemical conversion treatment performed to form the first dielectric layer reduced the insulation of the second dielectric layer, increased the LC index, and lowered the withstand voltage index V. In the electrolytic capacitor X3, the molar ratio Ti/Al in the second dielectric layer was larger than that in the electrolytic capacitor X4, and thus the LC index was further increased.

In the electrolytic capacitor X5, the second metal oxide layer was formed as the first dielectric layer and the first metal oxide layer was formed as the second dielectric layer, and thus no suppression layer was present between the second metal oxide layer and the anode body, and the chemical conversion treatment performed on the wound body reduced the insulation of the second metal oxide layer, increased the LC index, and lowered the withstand voltage index V.

In the electrolytic capacitor X6, the dielectric layer was constituted only by the first dielectric layer, and thus the capacitance index C was lowered. In the electrolytic capacitors X7 and X8,T1/T2 was larger than 1, and the capacitance index C was lowered.

The electrode foil for an electrolytic capacitor according to the present disclosure is suitably used for electrolytic capacitors for which large capacitance and low LC are required.

Although the presently preferred embodiments of the present invention have been described, such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications that fall within the true spirit and scope of the present invention.

### REFERENCE NUMERALS

10: anode foil, 110: anode body, 111: core portion, 112: porous portion, 120: dielectric layer, 121: first dielectric layer, 122: second dielectric layer, P: pit, 20: cathode foil, 30: separator, 40: winding end tape, 60A,60B: lead wire, 50A,50B: lead tab, 100: wound body, 200: wound-type electrolytic capacitor, 211: bottomed case, 212: sealing member, 213: base plate, 400: laminated-type electrolytic capacitor, 402: capacitor element, 403: outer body, 404: anode lead terminal, 405: cathode lead terminal, 406a: cathode forming portion, 406b: anode extraction portion, 407: dielectric layer, 408: cathode portion, 409: solid electrolyte layer, 410: cathode extraction layer, 411: carbon layer, 412: silver paste layer, 413: separation layer, 414: adhesive layer, 460: anode foil

What is claimed is:

1. An electrode foil for an electrolytic capacitor comprising:
an anode body that contains a valve action metal;
a first dielectric layer that covers at least a part of the anode body; and
a second dielectric layer that covers at least a part of the first dielectric layer,
wherein the second dielectric layer has a higher dielectric constant than the first dielectric layer,
a thickness T2 of the second dielectric layer is greater than a thickness T1 of the first dielectric layer, and
the first dielectric layer is a layer that suppresses oxygen diffusion from the second dielectric layer to the anode body.

2. The electrode foil for an electrolytic capacitor according to claim 1,
wherein the first dielectric layer contains a first metal oxide, and
the second dielectric layer contains a second metal oxide with a higher dielectric constant than the first metal oxide.

3. The electrode foil for an electrolytic capacitor according to claim 2, wherein the second metal oxide contains at least one second metal selected from the group consisting of tantalum, titanium, zirconium, niobium, and hafnium.

4. The electrode foil for an electrolytic capacitor according to claim 3, wherein the second metal oxide contains the second metal and at least one selected from the group consisting of silicon and aluminum.

5. The electrode foil for an electrolytic capacitor according to claim 2, wherein the first metal oxide contains at least one first metal selected from the group consisting of silicon and aluminum.

6. The electrode foil for an electrolytic capacitor according to claim 5,
wherein the first metal contains silicon, and
a ratio T1/T2 of the thickness T1 of the first dielectric layer to the thickness T2 of the second dielectric layer is 0.45 or less.

7. The electrode foil for an electrolytic capacitor according to claim 5,
wherein the first metal contains aluminum, and
a ratio T1/T2 of the thickness T1 of the first dielectric layer to the thickness T2 of the second dielectric layer is 0.6 or less.

8. The electrode foil for an electrolytic capacitor according to claim 1, wherein the thickness T1 of the first dielectric layer is 0.3 nm or more.

9. An electrolytic capacitor comprising:
the electrode foil for an electrolytic capacitor according to claim 1; and
a cathode portion that covers at least a part of the second dielectric layer.

10. The electrolytic capacitor according to claim 9, wherein the cathode portion contains an electrolyte.

11. The electrolytic capacitor according to claim 9, wherein the cathode portion contains a solid electrolyte.

12. A method for producing an electrode foil for an electrolytic capacitor, comprising:
a first step of preparing an anode body that contains a valve action metal;
a second step of forming a first dielectric layer that covers at least a part of the anode body; and
a third step of forming a second dielectric layer that covers at least a part of the first dielectric layer, after the second step,
wherein the second dielectric layer has a higher dielectric constant than the first dielectric layer,
a thickness T2 of the second dielectric layer is greater than a thickness T1 of the first dielectric layer, and
the first dielectric layer is a layer that suppresses oxygen diffusion from the second dielectric layer to the anode body.

13. The method for producing an electrode foil for an electrolytic capacitor according to claim 12, wherein in the second step, the first dielectric layer is formed through atomic layer deposition or chemical conversion treatment.

14. The method for producing an electrode foil for an electrolytic capacitor according to claim 12, wherein in the third step, the second dielectric layer is formed through atomic layer deposition.

15. The method for producing an electrode foil for an electrolytic capacitor according to claim 12,
wherein the first dielectric layer contains a first metal oxide, and
the second dielectric layer contains a second metal oxide with a higher dielectric constant than the first metal oxide.

16. The method for producing an electrode foil for an electrolytic capacitor according to claim 15, wherein the second metal oxide contains at least one second metal selected from the group consisting of tantalum, titanium, zirconium, niobium, and hafnium.

17. The method for producing an electrode foil for an electrolytic capacitor according to claim 16, wherein the second metal oxide contains the second metal and at least one selected from the group consisting of silicon and aluminum.

18. The method for producing an electrode foil for an electrolytic capacitor according to claim 15, wherein the first metal oxide contains at least one first metal selected from the group consisting of silicon and aluminum.

19. The method for producing an electrode foil for an electrolytic capacitor according to claim 18,
wherein the first metal contains silicon, and
a ratio T1/T2 of the thickness T1 of the first dielectric layer to the thickness T2 of the second dielectric layer is 0.45 or less.

20. The method for producing an electrode foil for an electrolytic capacitor according to claim 18,
wherein the first metal contains aluminum, and
a ratio T1/T2 of the thickness T1 of the first dielectric layer to the thickness T2 of the second dielectric layer is 0.6 or less.

21. The method for producing an electrode foil for an electrolytic capacitor according to claim 12, wherein the thickness T1 of the first dielectric layer is 0.3 nm or more.
